(19) United States
(12) Patent Application Publication
(10) Pub. No.: US 2013/0277236 A1
(43) Pub. Date: Oct. 24, 2013

(54) PROCESS AND DEVICE FOR REGULATING THE AIR DEMAND OF EXTRACTIVE MEROX UNITS

(71) Applicants: Christophe Hein, Triel Sur Seine (FR); Alain Houlier, Sainte Adresse (FR)

(72) Inventors: Christophe Hein, Triel Sur Seine (FR); Alain Houlier, Sainte Adresse (FR)

(73) Assignee: TOTAL RAFFINAGE MARKETING, PUTEAUX (FR)

(21) Appl. No.: 13/884,168

(22) PCT Filed: Nov. 22, 2011
(86) PCT No.: PCT/FR11/52719

§ 371 Date: Jun. 25, 2013

(30) Foreign Application Priority Data
Nov. 24, 2010 (FR) 10 59662

(51) Int. Cl. G01N 27/416

(52) U.S. Cl. CPC G01N 27/416
USPC 205/785.5; 204/400; 422/119

(57) ABSTRACT

Process and device for measuring the conversion of mercaptans to disulfides, in which the progress of the reaction for producing disulfides is monitored by measuring the redox potential.

A method and device for regulating the air demand of extractive Merox units. The present invention relates to a method for tracking the conversion of mercaptans into disulfides, in which a hydrocarbon load containing mercaptans is brought into contact with a basic aqueous solvent to produce a mercaptan-depleted hydrocarbon fraction and a mercaptan-enriched aqueous phase, said mercaptan-enriched aqueous phase being separated and brought into contact with a gas containing oxygen to produce insoluble disulfides and a regenerated basic aqueous solvent.

Liquefied petroleum gas (LPG) derived from crude oil fractionation, petroleum fractions or cracking methods generating it, is generally charged with light organo-sulfur compounds. Among the organo-sulfur compounds identified in this LPG, there are mercaptans such as methylmercaptan and ethylmercaptan, as well as hydrogen sulfide (H₂S). The mercaptans are compounds with the formula R—SH where R is a linear, ramified or cyclic alkyl group. The hydrogen sulfide (H₂S) is not therefore considered as a mercaptan in the present application. The mercaptans likely to be present in an LPG generally exhibit a C₁-C₆ carbonated chain, although longer carbonated chains may also be present.

In addition to direct commercial use in motor vehicles with controlled ignition, LPG is a raw material useful in producing ethyl tert-butyl ether (ETBE) or methyl tert-butyl ether (MTBE), which are used in formulating commercial gasolines. The LPG used to produce ETBE/MTBE must have a sulfur content less than 15 ppm. This constraint makes it necessary to optimize the operation of the LPG “extractive Merox” units.

The “extractive Merox” units extract the mercaptans from the LPG and convert them into disulfides. The method can be summarized as follows: an LPG charged with sulfur compounds is washed by an alkaline aqueous solution, usually sodium hydroxide, in order to produce, on the one hand, a sulfur compound-depleted LPG and, on the other hand, an alkaline aqueous solution comprising mercaptans in salified form. The latter is separated and brought together with oxygen to transform the mercaptans into disulfides and water. The disulfide-forming reaction is usually catalyzed by cobalt phthalocyanine, according to a method developed by UOP. The disulfides obtained are not soluble in water and are separated by decanting. The separated alkaline aqueous solution is recycled. The cobalt phthalocyanine used remains in the alkaline aqueous solution.

The extractive Merox unit is controlled by varying the quantity of air injected into the catalytic zone so as to obtain a total conversion into disulfides with no excess of air. Operation with an excess of air results in an input of oxygen in the mercaptan extractor. The oxygen reacts with the mercaptans to form disulfides which will not be extracted by the alkaline aqueous solution and will remain in the LPG.

In the regenerated soda, the mercaptan content, in the form of sodium thiolates, should be between 30 and 100 ppm. CH₃CH₂SNa, CH₃SNa and C₆H₅SNa are nonlimiting examples of sodium thiolates. CH₃CH₂SH, CH₃SH and C₆H₅SH are nonlimiting examples of mercaptans.

Typically, the extractive Merox unit is controlled, with respect to the oxygen demand, by means of a visual test called “shake test”. This test consists in half-filling a transparent glass bottle with the soda solution after regeneration (the top part of the bottle containing air), in plugging the bottle and in shaking it until there is a color change. The color changes from blue to green when the cobalt catalyst changes degree of oxidation. If the color change occurs in less than 30 seconds, there may be an excess of air. The assessment of this color can vary depending on the operator performing the operation.

When the soda solution has a dark color, for example black (presence of impurities), the shake test is showing its limits. Similarly, a rapid change of color does not necessarily mean an excess of air but can also signify a low proportion of mercaptans or a highly active and/or highly concentrated catalyst. Moreover, a degraded or diluted soda solution will not be effective enough for extracting the mercaptans from the LPG and will also falsify the results.

There are therefore needs to obtain a reliable test for determining the oxygen demands of the alkaline aqueous solution, for example a 15% soda solution.

To this end, and according to a first aspect of the invention, the applicant has found a method for tracking the conversion of mercaptans into disulfides, in which a hydrocarbon load containing mercaptans is brought into contact with a basic aqueous solvent to produce a mercaptan-depleted hydrocarbon fraction and a mercaptan-enriched aqueous phase, said mercaptan-enriched aqueous phase being separated and brought into contact with a gas containing oxygen to produce insoluble disulfides and a regenerated basic aqueous solvent, characterized in that the progress of the insoluble disulfide-producing reaction is monitored by measuring redox potential.

The applicant has found, surprisingly, that despite the many parameters likely to interfere with the measurement of the redox potential, the latter was able to be used to control the reaction, for example by monitoring the input of gas containing oxygen (O₂). The parameters likely to interfere are, for example, the temperature, the pH, the concentration of the redox couples in solution and their solubilities, a corrosive action of the measured solution and a poisoning of the measurement electrode by the sulfur compounds. Many redox couples are in fact likely to be present, originating for example from the catalyst used to catalyze the mercaptan-to-disulfide oxidation reaction, for example the phthalocyanine-complexed cobalt, but also originating from the different species of mercaptans present in the hydrocarbon load. The redox potential measurements performed in a corrosive environment can be falsified as a result of corrosion of the electrode. The basic aqueous solution used may in fact be a very basic 15% solution of soda. Similarly, it is known that some electrodes (for example the Ag/AgCl electrodes) are poisoned by H₂S which leads to their deterioration. Such poisoning is also likely to occur in the presence of other sulfur compounds, such as the mercaptans.

The electrodes that can be used are, for example, silver electrodes (Ag/AgCl), preferably comprising a protection, for example of polymer type.

The hydrocarbon load used preferably has an H₂S content less than or equal to 50 ppm by weight.

The hydrocarbon load may be a liquefied petroleum gas, for example derived from crude oil fractionation, petroleum fractions or cracking methods. The H₂S content of the load may, for example, be reduced to a content less than or equal to 50 ppm by weight by at least one wash using an appropriate alkaline aqueous solution.

The redox potential measurement is performed preferably on the regenerated basic aqueous solvent.

The input of gas containing oxygen is regulated according to the measured redox potential.

The basic aqueous solvent is advantageously soda at 10 to 20% by weight, for example 15% by weight. The input of gas containing oxygen is increased or reduced when the redox potential is, respectively, less than −550 mV or greater than −500 mV relative to a hydrogen normal electrode (ENH).

According to a second aspect, the invention relates to a unit for converting mercaptans into disulfides, comprising a first chamber in which a hydrocarbon load containing mercaptans is brought into contact with a basic aqueous solvent to produce a mercaptan-depleted hydrocarbon fraction and a mercaptan-enriched aqueous phase, said mercaptan-enriched aqueous phase being separated and brought into contact with an oxidant in a second chamber to produce insoluble disulfides and a regenerated basic aqueous solvent, the unit for converting mercaptans into disulfides also comprising means for measuring redox potential.

The unit for converting mercaptans into disulfides is, for example, of “extractive Merox” type.

The first chamber, configured to receive and bring into contact a hydrocarbon load containing mercaptans and a basic aqueous solvent to produce a mercaptan-depleted hydrocarbon fraction and a mercaptan-enriched aqueous phase, is, for example, a mercaptan extractor, notably intended for an “extractive Merox” unit.

The second chamber, configured to receive and bring into contact said separated mercaptan-enriched aqueous phase and an oxidant to produce insoluble disulfides and a regenerated basic aqueous solvent, is, for example, an oxidation reactor, notably intended for an “extractive Merox” unit.

The unit preferably comprises a third separation chamber in which the insoluble disulfides and the regenerated basic aqueous solvent are separated.

According to a preferred embodiment, the unit comprises a first duct for returning the regenerated basic aqueous solvent from the third chamber to the first chamber.

Advantageously, the means for measuring redox potential of the unit are arranged on the third chamber and/or on the first duct.

The means for measuring redox potential arranged on the first duct and/or on the third chamber comprise a probe for measuring redox potential coupled to a reading appliance.

The measuring means are advantageously connected to the first duct using a bypass duct.

The bypass duct may also comprise an isolating valve, a water intake for cleaning the measuring probe and the chamber supporting it, and a drain valve.

According to a third aspect, the invention relates to a kit for measuring the redox potential of a corrosive solution comprising (i) a duct feeding corrosive solution, (ii) a duct feeding water, (iii) a tank, (iv) a probe for measuring redox potential, (v) a drain, and optionally a reading appliance coupled to the probe.

Such a kit forms a device for sampling and measuring the redox potential of a corrosive solution, which can be used to implement the method according to the invention.

The kit may comprise means for isolating the different sections consisting of (i) the duct feeding corrosive solution and/or (ii) the duct feeding water and/or (ii) the tank, and/or (iii) the drain.

In particular, the kit comprises a tank equipped with a potential-measuring probe, a duct intended to feed the tank with corrosive solution, a duct intended to feed the tank with water, a drain for the tank, at least one means for isolating the duct feeding corrosive solution and at least one means for isolating the duct feeding water. These isolation means are, for example, valves.

The probe for measuring redox potential, optionally coupled to a reading appliance, optionally comprises means for coupling to means for regulating the feed of gas containing oxygen such as those present in a mercaptan conversion unit according to the second aspect of the invention.

According to a fourth aspect, the invention relates to the use of the kit according to its third aspect, in a refining installation, or even a refining installation comprising a sampling and measuring kit or device according to the invention.

The use of the kit may comprise the steps of:
connecting the duct feeding corrosive solution to a chamber of a refining installation containing said corrosive solution to be measured,
connecting the duct feeding water to a water source,
controlling the opening of the means for isolating the duct feeding corrosive solution to fill the tank, then closing the isolation means,
measuring the redox potential of the solution contained in the tank by means of the measurement probe,
draining the tank via the drain,
controlling the opening of the means for isolating the duct feeding water to rinse the measurement probe, then closing the isolation means.

This use may optionally comprise a step for controlling gas feed regulating means for a chamber from which the corrosive solution to be measured originates, for example an oxidation reactor, in order for the measured redox potential to lie within a predetermined range of values.

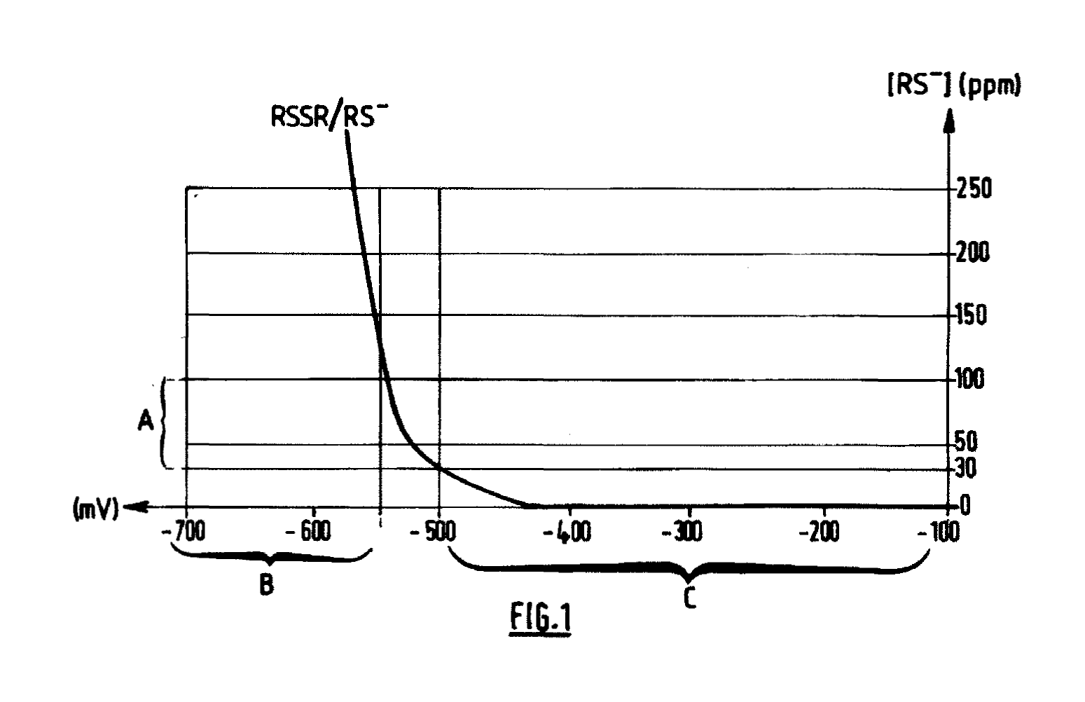

The invention is now described with reference to the attached FIGS. 1-5, which describe, in a nonlimiting manner, the invention according to its various aspects.

FIG. 1 is a graph showing the variation of mercaptan redox potential in soda at 15%, when the concentration of mercaptans varies.

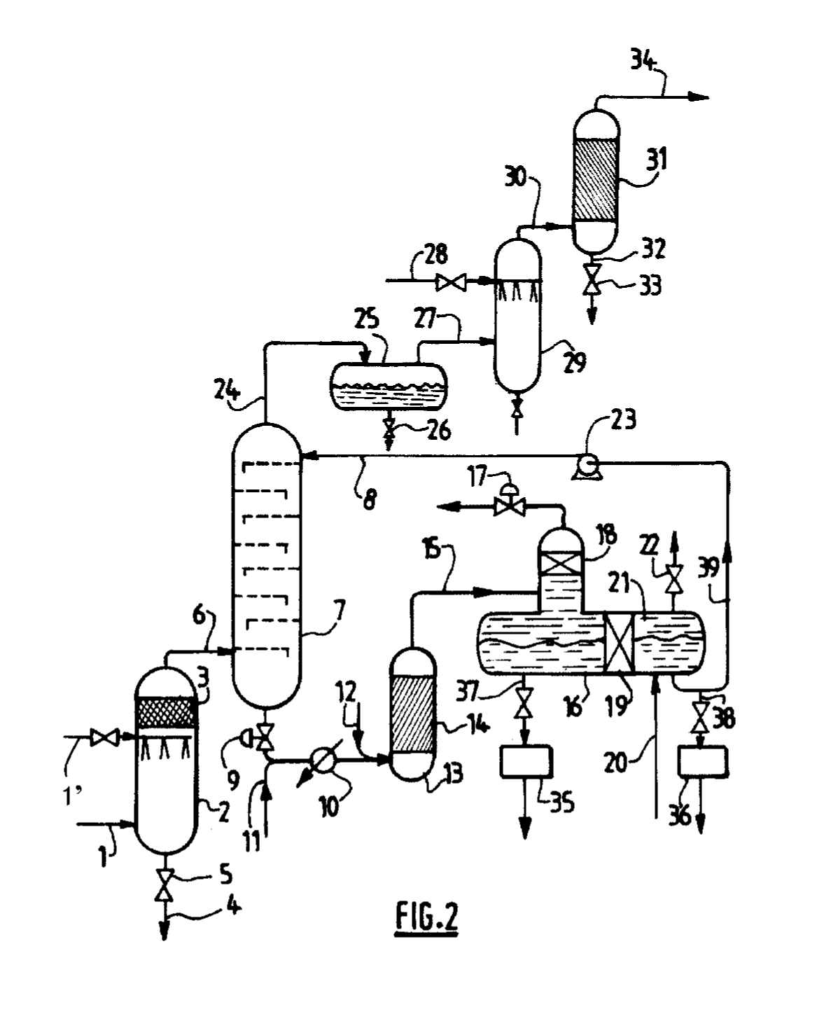

FIG. 2 represents a diagram of an extractive Merox unit for desulfurizing an LPG.

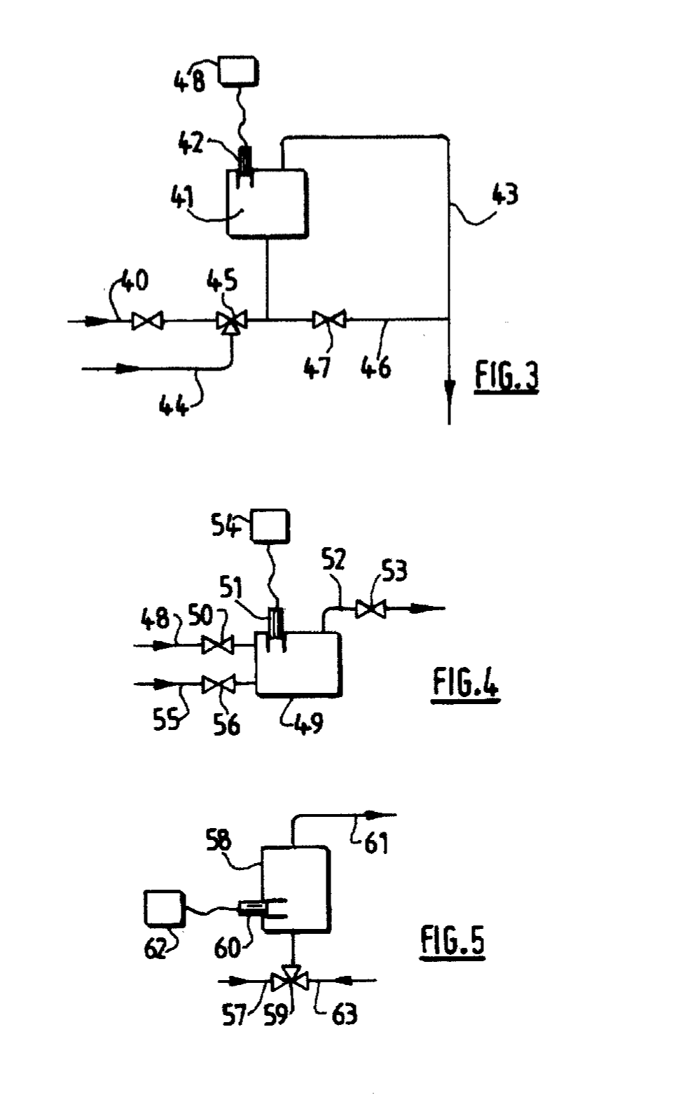

FIG. 3 represents a kit for measuring redox potential, in the form of a diagram.

FIGS. 4 and 5 represent a variant of the kit presented in FIG. 3.

In FIG. 1 a solution of soda at 15% by weight has mercaptan ethyl added to it and its redox potential is measured at 20° C. at atmospheric pressure relative to the hydrogen normal electrode.

The curve which represents the variation of the concentration of mercaptans of the soda solution at 15% by weight as a function of the redox potential exhibits a first inflection in the region of −500 mV and a second inflection in the region of −550 mV. This curve is representative of the potential at which the mercaptans (in the form of anions, represented symbolically by RS⁻) are oxidized into disulfides (symbolically represented by RSSR).

In operation, the setpoint of concentration of mercaptans in the regenerated soda derived from an extractive Merox is usually between 30 and 100 ppm (zone A). Thus, in the present case, a redox potential of between −500 mV and −550 mV is maintained. When the measured redox potential is less than −550 mV (zone B), there is an oxidation defect which can be eliminated by increasing the air flow rate into the installation. When the measured redox potential is greater than −500 mV (zone C), there is an excess of air which can be corrected by reducing the air flow rate into the installation.

In FIG. 2, which represents a conventional LPG desulfuration installation of extractive Merox type equipped with a device according to the invention, LPG 1 is introduced at the foot of a sampling balloon vessel 2 equipped with a coalescing section 3. An aqueous solution of cooled soda 1′ is introduced under the coalescing section in order to eliminate the residual H₂S in the form of sodium sulfide NaSH in solution in the spent soda 4, drawn off by means of a valve 5 at the bottom of the balloon vessel 2. The washed LPG 6 passes through the coalescing section and is introduced at the foot of a mercaptan extractor 7 forming a first chamber in the sense of the invention. The extractor 7 operates in counter-current mode. A solution of mercaptan-depleted soda 8 is introduced at the head of the extractor 7 and reacts with the mercaptans present in the LPG to form sodium thiolates and spent soda. The sodium thiolates are driven into the spent soda at the bottom of the extractor 7, then drawn off by means of a controlled valve 9. The latter are optionally mixed with a top-up of an oxidation catalyst 11 then reheated in a heat exchanger 10. An oxidizing gas 12, for example air, is added to the reheated mixture obtained from the heat exchanger 10, then is introduced at the foot of an oxidation reactor 13 forming a second chamber in the sense of the invention. The oxidation reactor 13 advantageously comprises an internal lining 14 in order to increase the contact between the oxidizing gas 12 and the spent soda rich in sodium thiolates. The sodium thiolates are oxidized by the oxidizing gas 12 to form disulfides using the oxidation catalyst 11 within the oxidation reactor 13 to produce a three-phase mixture of oxygen-depleted air (O₂), insoluble disulfides and regenerated soda 15. The three-phase mixture 15 is introduced into a separator 16, forming a third chamber in the sense of the invention, in which the oxygen-depleted air passes through a separation section 18 which may be formed, for example, by Raschig rings, then is eliminated at the head by means of a controlled valve 17. The disulfides are separated from the regenerated soda by decanting within the separator 16 and pass through a filtration section 19 which may contain coal. The extraction of the disulfides from the regenerated soda can optionally be facilitated by the addition of dry cleaning solvent 20 which will drive the residual disulfides into the supernatant 21 comprising most of the disulfides and a bottom aqueous phase consisting of the mercaptan-depleted soda 8. The supernatant 21 is collected on the valve 22 to then be transported to a hydrotreatment section or a heavy gasoline Merox reactor, not represented in this figure. The mercaptan-depleted soda is returned to the head of the extractor 7 in a first duct 39 by means of pump 23 for a new extraction cycle. The LPG stripped of the mercaptans 24 is collected at the head of the extractor 7 to then be sent into a gravity separator 25 in order to eliminate the soda which has been driven with the LPG. The residual soda is collected by a drain valve 26. The remaining LPG 27 is washed by water 28 in a first vessel 29 to produce washed LPG 30. The washed LPG 30 is returned into a second vessel 31 to be filtered therein on a sand bed to strip it of the water 32. The water 32 is drawn off at the foot by a valve 33. The LPG stripped of water 34 is collected at the head.

When the quantity of oxygen (O₂) added to the oxidation reactor 13 is insufficient, the reaction oxidizing the mercaptans into disulfides is incomplete, so that there remain mercaptans in the three-phase mixture of oxygen-depleted air, insoluble disulfides and regenerated soda 15 leaving the oxidation reactor 13. These mercaptans collect in the mercaptan-depleted soda 8 reinjected at the head of the mercaptan extractor 7 and in the LPG collected at the head of the extractor 7.

When the quantity of oxygen added to the oxidation reactor 13 is too great, the oxygen is not fully consumed and collects in the three-phase mixture of oxygen-depleted air, insoluble disulfides and regenerated soda 15 leaving the oxidation reactor 13, then in the mercaptan-depleted soda 8 reinjected at the head of the mercaptan extractor 7. The presence of oxygen (O₂) dissolved in the mercaptan-depleted soda 8 leads to the formation of disulfides in the mercaptan extractor 7, which will collect in the LPG collected at the head of the extractor 7.

Thus, an excess of air or a lack of air, in other words an excess of O₂ or a lack of O₂, results in an LPG containing mercaptans or disulfides and not meeting the specifics required for ETBE/MTBE production.

A device for measuring redox potential according to the invention can be incorporated into the conventional LPG desulfurizing installation described above. Such a device makes it possible to control the feed of air 12 in order for the oxidation reaction within the oxidation reactor 13 to be complete.

In FIG. 2, a device for measuring redox potential 35, 36 can be positioned respectively (i) on a first sampling duct 37 positioned directly on the extractor 7 and/or (ii) on a second sampling duct 38, positioned on the first duct 39, in order to be able to measure the redox potential of the bottom aqueous phase, that is to say the regenerated soda. In FIG. 2, the first sampling duct 37 is placed before the filtration section 19. However, it can also be placed after the filtration section 19, for example close to the offtake of the first duct 39 on the extractor 7.

FIG. 3 shows a sampling and redox potential measuring device according to the invention. A duct 40 brings the regenerated soda to a tank 41. The tank 41 comprises a redox potential measuring electrode 42 as well as an evacuation duct 43. The redox potential measuring electrode 42 is connected to a reading appliance 48, and/or to a signal processing system, not represented, for example a computer. A feed of water 44 is connected to the duct 40 at a three-way valve 45 upstream of the tank 41. The feed of water 44 is open when the duct 40 is closed, in order to rinse the tank 41 and the electrode 42. This step makes it possible to preserve the life of the electrode 42 and to limit the risks of chemical burns when it is replaced. A drain duct 46 provided with a valve 47 is connected at one end to the duct 40 and at the other end to the evacuation duct 43. For design reasons, it is preferable to position the evacuation duct 43 on the top of the tank 41. Similarly, it is preferable to position the valves 45 and 47 as close as possible to the tank 41 in order to limit the dead volumes. Finally, it is desirable to avoid having air introduced into the tank 41, at the risk of falsifying the redox potential measurement. Moreover, the tank 41 will have the smallest possible volume, in order to improve the response time of the electrode 42 and to limit the losses of regenerated soda.

FIG. 4 represents a first alternative sampling and redox potential measuring device according to the invention. A duct 48 brings the regenerated soda to a tank 49. A valve 50 placed on the duct 48 close to the tank 49 makes it possible to cut the liquid flow as necessary. The tank 49 comprises a redox potential measuring electrode 51 as well as an evacuation duct 52 provided with a valve 53. The redox potential measuring electrode 51 is connected to a reading appliance 54, and/or to a signal processing system, not represented, for example a computer. A feed of water 55 is connected to the tank 49 at a valve 56 placed close to the tank 49. The feed of water 55 is open when the duct 48 is closed, in order to rinse the tank 49 and the electrode 51. This step makes it possible to preserve the life of the electrode 51 and to limit the risks of chemical burns when it is replaced. For design reasons, it is preferable to position the evacuation duct 52 on the top of the tank 49. Similarly, it is preferable to position the valves 50 and 56 as close as possible to the tank 49 in order to limit the dead volumes and the transition times between the regenerated soda solution and the water. Finally, it is necessary to avoid having air introduced into the tank 49, at the risk of falsifying the redox potential measurement. Moreover, the tank 49 will have the smallest possible volume, in order to improve the response time of the electrode 51 and to limit the losses of regenerated soda.

FIG. 5 represents a second alternative sampling and redox potential measuring device according to the invention. A duct 57 brings the regenerated soda to a tank 58 via a three-way valve 59. The tank 58 comprises a redox potential measuring electrode 60 as well as an evacuation duct 61. The redox potential measuring electrode 60 is connected to a reading appliance 62, and/or to a signal processing system, not represented, for example a computer. A feed of water 63 is connected to the tank 58 at the three-way valve 59. The feed of water 63 is open when the duct 57 is closed, in order to rinse the tank 58 and the electrode 60. This step makes it possible to preserve the life of the electrode 60 and to limit the risks of chemical burns when it is replaced. For design reasons, it is preferable to position the evacuation duct 61 on the top of the tank 58. Similarly, it is preferable to position the valve 59 as close as possible to the tank 58 in order to limit the dead volumes. Finally, it is necessary to avoid having air introduced into the tank 58, at the risk of falsifying the redox potential measurement. Moreover, the tank 58 will have the smallest possible volume, in order to improve the response time of the electrode 60 and to limit the losses of regenerated soda.

### EXAMPLE 1

A device conforming to FIG. 3 is installed on an extractive Merox unit of a design similar to that described in FIG. 2, on the first output duct 39 for the regenerated soda 8 originating from the separator 16. The tank 41 has a 500 ml capacity. A portion of the regenerated soda circulating in the first duct 39 is diverted into the duct 40 and fills the tank 41. The excess regenerated soda 8 flows through the drain duct 43. The redox potential is measured (at 20° C., at atmospheric pressure) by means of a redox probe made of polymer (polysulfone) with EMC 233 model gel electrolyte. The value of the redox potential is obtained after stabilization of the measurement. At the end of the measurement, the three-way valve 45 is operated and water from the duct 44 is used to rinse the tank 44, whereas the feed of regenerated soda 8 is stopped. When the measured redox potential is less than −550 mV (ENH), the air flow rate admitted at the input of the oxidation reactor 13 is increased. When the redox potential is greater than −500 mV (ENH), the air flow rate admitted at the input of the oxidation reactor 13 is reduced.

The use of this technique has made it possible to raise the conformity rate of the LPG used to manufacture ETBE from 20% to 80%, over an annual average, the remaining nonconformities being attributed to other operational issues, notably linked to the presence of residual H₂S.

### EXAMPLE 2

A device conforming to FIG. 3 is installed in the laboratory. A vessel C containing 2800 ml of soda at 15% containing a few drops of oxidation catalyst Europhtal 8090 (cobalt phthalocyanine) is de-aerated in argon for 30 minutes. This vessel is connected to the device conforming to FIG. 3 at the duct 40. The gaseous roof of the tank 41 and the ducts that are connected thereto are de-aerated with argon. Known weights of octanethiol are injected into the vessel C in order to obtain mercaptan concentrations ranging from 0 to 160 ppm (by weight). The redox potential is recorded after stabilization of the measurement (at 20° C., at atmospheric pressure), by using the same probe as in example 1.

| | Octanethiol (ppm/m) | | | | | | |
|---|---|---|---|---|---|---|---|
| | 0 | 43 | 64 | 92 | 130 | 161 | 161 |
| Potential (ENH) (mV) | −293 | −508 | −530 | −544 | −569 | −590 | −645 |

Three eight-hour aging tests in the soda at 15% were carried out. After each test, a check on the electrode by means of a reference fluid (Hanna HI7021 at 240 mV) is performed in order to observe whether an abnormal aging of the electrode has occurred. The latter did not register any drift, which shows that the integrity of the electrode was not affected.

1. A method for tracking the conversion of mercaptans into disulfides, in which a hydrocarbon load containing mercaptans is brought into contact with a basic aqueous solvent to produce a mercaptan-depleted hydrocarbon fraction and a mercaptan-enriched aqueous phase, said mercaptan-enriched aqueous phase being separated and brought into contact with a gas containing oxygen to produce insoluble disulfides and a regenerated basic aqueous solvent, characterized in that the progress of the insoluble disulfide-producing reaction is monitored by measuring redox potential.

2. The method as claimed in claim 1, in which the redox potential measurement is performed on the regenerated basic aqueous solvent.

3. The method as claimed in claim 1, in which the input of gas containing oxygen is regulated according to the measured redox potential.

4. The method as claimed in claim 2, in which the basic aqueous solvent is soda.

5. The method as claimed in claim 4, in which the basic aqueous solvent is soda at 10 to 20% by weight.

6. The method as claimed in claim 3, in which the input of gas containing oxygen is increased or reduced when the redox potential is, respectively, less than −550 mV or greater than −500 mV relative to a hydrogen normal electrode.

7. The method as claimed in claim 1, in which the hydrocarbon load has an H₂S content less than or equal to 50 ppm by weight.

8. A unit for converting mercaptans into disulfides, comprising a first chamber configured to receive and bring into contact a hydrocarbon load containing mercaptans and a basic aqueous solvent to produce a mercaptan-depleted hydrocarbon fraction and a mercaptan-enriched aqueous phase, a second chamber configured to receive and bring into contact said separated mercaptan-enriched aqueous phase and an oxidant to produce insoluble disulfides and a regenerated basic aqueous solvent, characterized in that it comprises means for measuring redox potential.

9. The unit as claimed in claim 8, characterized in that it comprises a third chamber in which the insoluble disulfides and the regenerated basic aqueous solvent are separated.

10. The unit as claimed in claim 9, characterized in that it comprises a first duct for returning the regenerated basic aqueous solvent from the third chamber to the first chamber.

11. The unit as claimed in claim 10, characterized in that the means for measuring redox potential are arranged on the third chamber and/or on the first duct.

12. The unit as claimed in claim 8, characterized in that the measuring means are connected to the first duct using a bypass duct.

13. The unit as claimed in claim 12, characterized in that the bypass duct also comprises an isolating valve, a water intake for cleaning the measurement probe and the chamber supporting it, and a drain valve.

14. The unit as claimed in claim 8, characterized in that the means for measuring redox potential comprise a probe for measuring redox potential coupled to a reading appliance.

15. A device for sampling and measuring the redox potential of a corrosive solution comprising a tank equipped with a potential-measuring probe, a duct intended to feed the tank with corrosive solution, a duct intended to feed the tank with water, a drain for the tank, characterized in that it comprises at least one means for isolating the duct intended to feed corrosive solution and at least one means for isolating the duct intended to feed water.

16. The device as claimed in claim 15, also comprising means for isolating the different sections consisting of (i) the duct feeding corrosive solution and/or (ii) the duct feeding water and/or (ii) the tank, and/or (iii) the drain, and in that the potential-measuring probe, optionally coupled to a reading appliance, optionally comprises means for coupling to means for regulating the feed of gas containing oxygen.

17. The use of the device as claimed in claim 15, in a refining installation.
